(19) United States
(12) Patent Application Publication
(10) Pub. No.: US 2009/0037546 A1
(43) Pub. Date: Feb. 5, 2009

(54) FILTERING OUTBOUND EMAIL MESSAGES USING RECIPIENT REPUTATION

(75) Inventor: Steven T. Kirsch, Los Altos Hills, CA (US)

Correspondence Address: SCHNECK & SCHNECK, P.O. BOX 2-E, SAN JOSE, CA, 95109-0005, US

(73) Assignee: Abaca Technology, San Jose, CA (US)

(21) Appl. No.: 12/183,880

(22) Filed: Jul. 31, 2008

Related U.S. Application Data
(60) Provisional application No. 60/953,632, filed on Aug. 2, 2007.

(51) Int. Cl. G06F 15/16

(52) U.S. Cl. 709/206

(57) ABSTRACT

A method for filtering email messages by using reputations associated with recipients of the email messages to determine if senders of the email messages are spammers and correspondingly if the email messages are spam. Recipient reputations may be established based on counts of unique good senders and unique bad senders sending email messages to the recipients or by comparing sender email activity to bad recipients.

### CROSS-REFERENCE TO RELATED APPLICATION

This application claims priority from U.S. Provisional Patent Application Ser. No. 60/953,632, entitled “OUTBOUND FILTERING,” filed Aug. 2, 2007, which is hereby incorporated by reference in its entirety.

### TECHNICAL FIELD

The present invention relates generally to filtering email spam messages, and more specifically to filtering outbound email spam messages.

### BACKGROUND

Unwanted email, also known as spam, bulk email, or junk email, usually involves sending nearly identical unsolicited email messages to numerous recipients by email causing annoyance, inconvenience, and damage. Spam has been estimated to cost US businesses over a billion dollars per year. Senders of spam are known as “spammers.” Since the cost to spammers for sending spam to large numbers of recipients is small, spammers have no incentive to limit their mailings either by size or to recipients who might be interested in receiving the email messages.

Email system providers may include large well known providers such as Yahoo!®, small local providers, businesses offering email services to employees, organizations offering email services to members, etc. Huge volumes of spam overload email servers, delay and prevent delivery of email messages, and use up bandwidth. The email system providers are forced to invest in additional facilities and equipment to support legitimate users and legitimate email messages which are crowded out by spam thereby incurring significant costs. Email system providers incur costs. Email system providers do not wish to release outbound spam (i.e., sent by their own users) from their sites. A recipient of the outbound spam may be another user of the same email systems provider, a user of a different email system provider, a recipient providing his or her own independent email system, etc. Email system providers wish to prevent the release of spam from their site and to remove the users who are spammers from their email systems. If outbound spam sent by the users can be reduced, email system providers may recapture bandwidth and provide improved service to legitimate users without additional investment.

Email system providers may become blacklisted if they are recognized as a site from which spam emanates. Once blacklisted, other email system providers may prohibit delivery of email messages from the blacklisted email system provider. Inability to deliver email messages may result in loss of users, business, etc.

Email system providers wish to avoid bad publicity and loss of business that may ensue. Becoming publicly identified as being blacklisted or as a source of spam may make it difficult for a provider of email systems to conduct business, attract new users, retain current users, etc.

By not releasing spam sent by their users, email system providers may be placed on whitelists thus ensuring that email messages sent by legitimate users will be delivered. This will also generate good publicity, help conduct business, help attract new users, retain current users, etc.

There are currently several ways for a provider of email systems to filter outbound email messages before releasing them for delivery to recipients.

Email system providers may try to prevent spammers from becoming users. This may be done with the use of background checks or Human Interactive Proofs (HIPs). One type of Human Interactive Proofs are known as “CAPTCHA,” which is an acronym for “Completely Automated Public Turing Test to tell Computers and Humans Apart.” Spammers circumvent these techniques with the use of identity theft, hiring people to respond to the proofs and tests, or through the dissemination of viruses and malware to create botnets of controlled zombie computers which are used to send spam. The botnets of zombie computers obviate the need for spammers to become a user of an email system to launch the spam themselves. In fact, botnets of zombie computers have become a method of choice for sending spam.

Email system providers may require that a sender incur some computational cost for each email message. This method slows down computers sending spam. However spammers may circumvent the computational cost by maintaining a computation farm of computers, either their own computers or zombie computers.

Email system providers may filter outbound email messages by scanning the email message content for indications that the email message is spam. Spammers change, hide, and constantly try to defeat the criteria that are checked for email message content. Spammers may disguise the email message content by misspelling words that would be easily detectable by a program yet are still understandable to a human being.

Email system providers may create thresholds with which to restrict the number of email messages which may be sent per day or the number of total recipients to which email messages may be sent by a given user per day. If the threshold is too low, legitimate users will not have their email messages released. If the threshold is too high, a great many of a spammer's email messages may be released.

The current methods for filtering outbound email messages are slow and unreliable. What is needed is a faster and more reliable system for filtering outbound email messages.

### SUMMARY

To resolve shortcomings for identifying outbound spam from an email system, the present invention uses a system and method based on characteristics of recipients of email messages to filter email messages. Email messages are not directly rated; rather, characteristics of recipients to whom email messages are sent are rated (“recipient ratings”) and the recipient ratings are used to rate the senders thereby determining whether the sender is likely to be a spammer and the email message is correspondingly likely to be spam. The present invention determines if the senders of the email messages are spammers, thus allowing an administrator to take appropriate action. Those skilled in the art will realize that the present invention may also be used to filter email messages entering the email system.

The email system is populated with senders and recipients of email messages. Senders are internal to the email system sending email messages. Recipients may be internal and/or external to the email system. Note that recipients may or may not receive the email messages, e.g., the administrator may choose to not release spammers' email messages for delivery. Both senders and recipients may be identified by their email addresses.

The present invention is performed by software. Hardware maintains and operates the email system and the present invention. Databases are maintained to store accumulated information and statistics required for the performance of necessary calculations and determinations.

In a first embodiment an email message, after being sent by a sender, is held while still in the email system and not yet released for delivery to recipients. A sender indicator, which is termed a “sender reputation,” is calculated using the recipient reputations of the unique recipients of the email message. Alternate embodiments may calculate the sender reputation using counts of the number of email messages sent to good and bad recipients by the sender regardless of whether the recipients are unique. Recipient reputations are likelihood ratios indicating a probability of the recipient receiving spam. A determination is then made, based on the sender reputation, whether the sender is likely to be a spammer and the email message is correspondingly spam. Good email messages may be released for delivery to the recipients and spam email messages may be blocked from delivery. The sender reputation is updated and, when appropriate, recipient reputations are updated. Of course, an administrator is notified when appropriate about the results of the calculations and determinations.

Accumulated information is kept in a first database which may be a central database. The accumulated information may include recipient and sender email addresses, the good and bad senders who send email messages to the recipients, the sender reputations, and various statistics and threshold values needed to perform the calculations and determinations.

In an alternate embodiment, bad recipients, who are more likely to have been sent spam than “ham” (legitimate email messages) compared to an average recipient, are identified and their email addresses are placed in a set of email addresses of bad recipients. The recipients whose email addresses are placed in the set of email addresses of bad recipients will be referred to as bad recipients and the set of email addresses of bad recipients will be referred to as the bad recipients list. Sender activity to “bad” recipients is recorded and used to determine if the sender is likely to be a spammer and the email message spam.

The bad recipients are identified in various ways which may include: using the recipient reputations; obtaining mailing lists from spammers; harvesting recipients of email messages from known spammers; etc. Once bad recipients are identified, their email addresses are placed on the bad recipients list. Optionally, recipients who are sent email messages from known good senders may be removed from the bad recipients list. What remains is a list of email addresses that indicate that persons who send email messages to such addresses are highly likely to be spammers.

In the alternate embodiment an email message is held while it is still in the email system and not yet released for delivery to recipients. Information, e.g., bad recipient information, is recorded for the bad recipients of the email message. The bad recipient information may include the recipient (email address), the sender (email address), and the time the email message was sent by the sender. In addition, a previously determined sender indicator, which for the alternate embodiment will be termed a sender status, is retrieved. If the previously determined sender status indicates that the sender is a spammer then the held email message is not released for delivery. If the previously determined sender status indicates that the sender is not a spammer then the held email message is released for delivery.

Periodically, the bad recipient information is used to determine the sender status of senders. Sender status may be determined by two calculations, either by calculating the number of unique bad recipients to whom the sender has sent email messages over a predetermined time interval, or by calculating the number of email messages the sender has sent to bad recipients over the predetermined time interval. The calculations are compared to threshold values and a determination is made whether the email activity of the sender to bad recipients over the predetermined time interval indicates that the sender is a spammer. If the sender status is unchanged then the new sender status calculations are updated. If the sender status has changed then the sender status is updated, the sender status calculations are updated, the administrator is notified of the sender status change, and, where appropriate, changes are made to recipient reputations and the bad recipient list.

Accumulated information is kept in a second database which may be a central database. The accumulated information may include recipient and sender email addresses, the good and bad senders who send email messages to the recipients, the sender status, the bad recipient information, and various statistics, threshold values, calculation time intervals, etc. needed to perform the calculations and determinations

### BRIEF DESCRIPTION OF THE DRAWINGS

FIG. 1 is a flowchart of a first method, using recipient reputations, for filtering outbound email messages.

FIG. 2 is a flow chart of an alternate method, using a bad recipient list, for filtering outbound email messages.

FIG. 3 is a flow chart of the sender status retrieval step in the method of FIG. 2.

### DETAILED DESCRIPTION

### Definitions

“Ham” is an email message that a recipient normally wants to receive.

“Spam” is an email message that a recipient normally does not want to receive.

“Good” pertains to a preponderance of ham.

“Bad” pertains to a preponderance of spam.

“Spammer” is a sender who is more likely to send spam than to send ham.

“Recipient” is an email address to which an email message is sent.

“Recipient reputation” is a ratio indicating a likelihood that email messages sent to a recipient's email address, as compared to the average recipient are from good senders. Recipient reputation is calculated as (a count of unique ham senders sending email messages to the recipient/a count of unique spam senders sending email messages to the recipient)/(a count of unique ham senders sending email messages the average recipient/a count of unique spam senders sending email messages the average recipient). In general, a recipient reputation greater than one indicates a recipient more likely to receive ham and a recipient reputation less than one indicates a recipient more likely to receive spam. A recipient reputation that is approximately one is indeterminate and does not easily classify a recipient.

“Average recipient” is defined as a hypothetical recipient of every email message sent by the senders.

“Good recipients” are recipients of email messages who are more likely to have been sent ham than spam compared to the average recipient. Good recipients are also recipients whose email addresses are not included in the set of email addresses of bad recipients; they are not on the bad recipients list.

“Bad recipients” are recipients of email messages who are more likely to have been sent spam than ham compared to the average recipient. Bad recipients are also recipients whose email addresses are included in the set of email addresses of bad recipients; they are on the bad recipients list.

“Bad recipients list” is a list of recipients who have been determined to be more likely to have been sent spam than ham.

“Bad recipient information” is information recorded for email messages sent to recipients on the bad recipients list which may include the bad recipient, the sender, and the time the email message was sent by the sender.

“Bad recipients count” is a number of unique bad recipients to which the sender sent email messages during a predetermined time interval

“Bad messages count” is a number of email messages the sender sent to bad recipients during the predetermined time interval.

“Sender” is defined as an email address from which an email message is sent from an email system.

“Sender indicator” represents a likelihood that an email message sent by the sender is spam.

“Sender reputation” is the term used for the sender indicator of the first embodiment. Sender reputation is calculated, for an email message, by multiplying the stored sender reputation by the recipient reputations of the unique recipients of the email message.

“Sender status” is the term used for the sender indicator of an alternate embodiment.

“Unique” as applied to senders or recipients indicates that the sender or recipient is only counted once. For example, if sender A sends numerous email messages to recipient B, then sender A, is a unique sender for recipient B. In another example, if recipient B is listed more than once as a recipient for an email message sent by sender A, (recipient B may be listed individually and as part of a mailing list on the email message) then recipient B is a unique recipient of the email message from sender A.

### Description

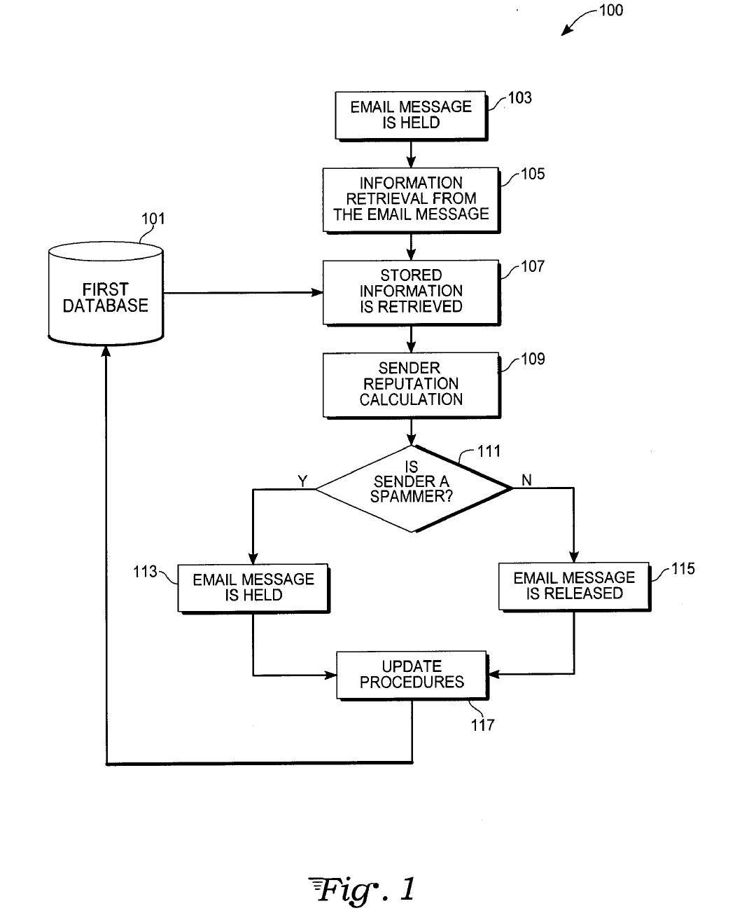

FIG. 1 shows an exemplary schematic of a computer-based system 100 to filter outbound email messages using recipient reputations in accordance with a first embodiment of the invention. Using recipient reputations to determine whether a sender is a spammer allows for very quick recognition of a sender changing from a good sender to a spammer and vice-versa. Since zombies and botnets have become the preferred tools of spammers, this is vital. A good user, when suddenly taken over by zombie software to become a zombie, will be quickly turned into a spammer sending email messages to recipients with mostly spam-like reputations. Once the zombie software is removed, the user will be quickly turned back into a good user sending email messages to recipients with mostly ham-like reputations.

Referring to FIG. 1, in step 103, an email message, sent by a sender from an email system, is held prior to release for delivery so a determination may be made whether the sender is a spammer.

Step 105 retrieves information from the email message. The retrieved information may include sender and recipient email addresses. The addresses, as is well known in the art, may be retrieved from the SMTP commands in the envelope of the email message. The sender's email address is retrieved from the MAIL FROM STMP command and the recipient addresses are retrieved from the RCPT TO SMTP commands. In other embodiments the addresses may be retrieved from the header of the email message, however, this not reliable since the addresses in the header may be altered (“spoofed”) by the sender.

Step 107 retrieves from a first database 101, accumulated information which is relevant to the previously retrieved sender and recipient addresses. Accumulated information in the first database 101 includes many types of information. For a sender, the accumulated information in the first database 101 may include the sender's address and a sender indicator which is referred to as a sender reputation. For a recipient, the accumulated information in the first database 101 may include the recipient's email address, the unique good senders sending email messages to the recipient, the unique bad senders sending email messages to the recipient, a count of the unique good senders, and a count of the unique bad senders. In addition, accumulated information in the first database 101 may include various threshold values such as values used for rating sender and recipient reputations. Retrieving stored information in step 107 retrieves accumulated information pertaining to the sender and recipient addresses of the email message. Accumulated information pertaining to threshold values and an average recipient is also retrieved.

Once the stored information is retrieved in step 107, a sender reputation calculation is performed using recipient reputations in step 109. The sender reputation calculation 109 is made by multiplying the sender reputation obtained from the first database 101 when stored information is retrieved in step 107 with the recipient reputations of the unique recipients of the email message that are obtained from the first database 101 when stored information is retrieved.

The recipient reputations for the unique recipients of the email message are calculated using the counts obtained when stored information is retrieved in step 107. These recipient reputations are then multiplied with the sender reputation which is also obtained when stored information is retrieved in step 107.

If the sender is new and there is not yet any information pertaining to the sender in the first database 101, a sender reputation may be initialized with a value of one (1). The new sender reputation is then multiplied by the recipient reputations of the unique recipients of the email message for the sender reputation calculation in step 109.

If a recipient is new and there is not yet any information pertaining to the recipient in the first database 101, both the count of unique ham senders sending email messages to the recipient and the count of unique spam senders sending email messages to the recipient may be initialized with the counts for the average recipient. The recipient reputation is then calculated using the counts of the average recipient yielding a value of one (1) for the recipient reputation of the new recipient which is then used in the sender reputation calculation in step 109.

Once the sender reputation calculation is performed in step 109 the newly calculated sender reputation is used to determine “Is sender a spammer?” in step 111. A sender reputation greater than one indicates a sender more likely to send ham; a sender reputation less than one indicates a sender more likely to send spam; and a sender reputation of approximately one is indeterminate and does not easily classify a sender. Threshold values obtained when stored information is retrieved in step 107 are used in step 111 to determine “Is sender a spammer?”. These threshold values may be set and changed by the administrator to best reflect conditions in a particular email system. For example, threshold values greater than 1.25 may be set to indicate that the sender is a good sender. Threshold values less than 0.75 may be set to indicate that the sender is bad sender. Threshold values between 0.75 and 1.25 may be set as indeterminate values.

If in step 111 the answer to “Is the sender a spammer” is yes, then in step 113 the email message is held and not delivered to the recipients. If the answer to “Is the sender a spammer” is no, the in step 115 the email message is released for delivery to the recipients. Next, step 117 performs update procedures. The update procedures may include updating the sender reputation in the first database 101, updating stored information for the recipients in the first database 101, notifying the administrator of a change in the sender reputation, notifying the administrator that the mail message has been held and not released for distribution to the recipients, etc.

The step 117 update procedures for updating stored information for the recipients in the first database 101 are done when the sender reputation changes. The sender reputation change requires changes to be made for the recipients of the email message and for the average recipient. These changes are for the unique good senders sending email messages, the unique bad senders sending email messages, the count of the unique good senders, and the count of the unique bad senders.

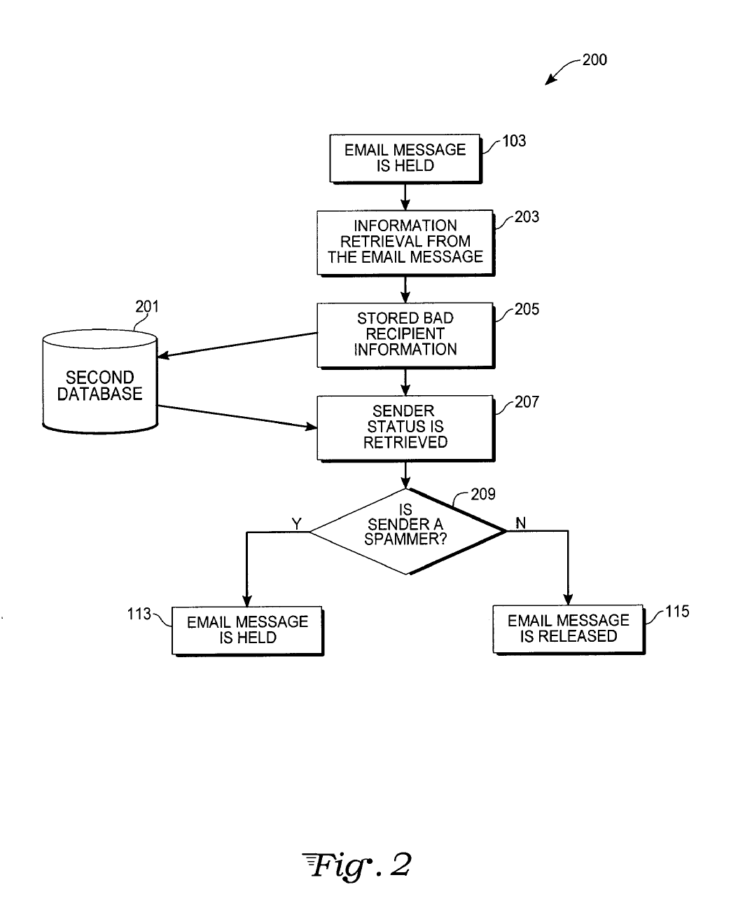

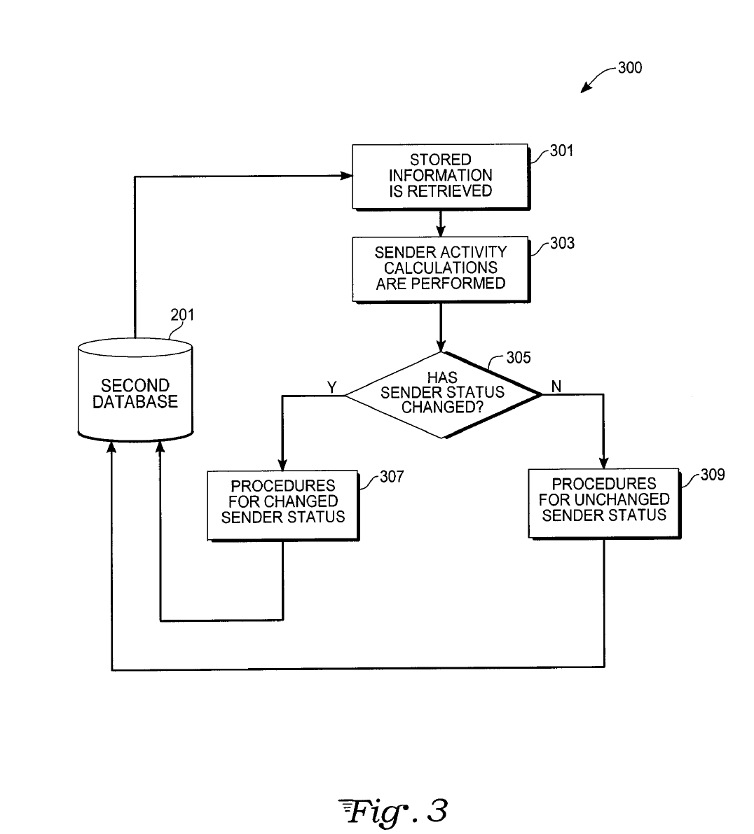

FIGS. 2 and 3 show an alternate embodiment, filtering outbound email messages using bad recipients. In the alternate embodiment a sender may be identified as a spammer by comparing the sender's activity sending email messages to recipients who have been identified as bad recipients and placed in a set of email addresses of bad recipients which is stored as accumulate information in a second database 201 (FIGS. 2 and 3). The second database 201 stores accumulated information much in the same manner as the first database 101 (FIG. 1). The recipients placed in the set of email addresses of bad recipients are referred to as bad recipients and the set of email addresses of bad recipients is referred to as the bad recipients list. The bad recipients list contains email addresses that are highly likely to indicate that the sender who sends email messages to such addresses is a spammer.

The bad recipients list may be compiled in any of several ways. As in the first embodiment, accumulated information for recipients may be stored in the second database 201 (FIGS. 2 and 3). This accumulated recipient information may include the recipient's email address, the unique good senders sending email messages to the recipient, the unique bad senders sending email messages to the recipient, a count of the unique good senders sending email messages to the recipient, and a count of the unique bad senders sending email messages to the recipient. Analogous accumulated information may also be stored for the average recipient. This accumulated recipient information may be used to determine recipient reputations and recipients with low recipient reputations may be placed on the bad recipients list. Mailing lists may be obtained by purchase or subterfuge from spammers and the addresses added to the bad recipients list. Recipients of the email messages from senders in the email system who are known to be spammers may be harvested and added to the bad recipients list. This can be accomplished by allowing spammers to continue sending email messages while not releasing the email messages for distribution to the recipients. Optionally, any recipient addresses that have been obtained for the bad recipients list but which do receive email messages from good senders in the email system may be removed from the bad recipients list.

In addition to storing the recipient information and the bad recipients list in the second database 201 (FIGS. 2 and 3), the second database 201 contains other accumulated information. For a sender, the accumulated information in the second database 201 may include the sender's address, a sender indicator which in the alternate embodiment is referred to as a sender status, and previously calculated sender activity sending email messages to bad recipients. Accumulated bad recipient information is kept in the second database 201. The accumulated bad recipient information is information recorded for email messages sent to the bad recipients and may include the bad recipient, the sender, and the time the email message was sent by the sender. In addition, accumulated information in the second database 201 may include various threshold values such as predetermined time intervals for the calculation of sender activity sending email messages to bad recipients, and values for determining the sender status from the calculated sender sending email messages activity to bad recipients.

FIG. 2 shows an exemplary schematic of a computer-based system 200 for filtering outbound email messages using bad recipients. In step 103 an email message, sent by a sender from an email system, is held prior to release for delivery to recipients so that a determination may be made whether the sender is a spammer.

Step 203 retrieves from the email message information which may include a sender email address, recipient email addresses, and the time the email message was sent by the sender. The addresses, as is well known in the art, may be retrieved from the SMTP commands in the envelope of the email message. The sender's email address is retrieved from the MAIL FROM SMTP command and the recipient addresses are received from the RCPT TO SMTP commands. In other embodiments the addresses may be retrieved from the header of the email message, however, this not reliable since the addresses in the header may be altered by the sender.

Once the sender address, the recipient addresses, and the time the email message was sent by the sender are retrieved from the email message in step 203, step 205 uses this information to store bad recipient information in the second database 201. The following is stored for the bad recipients of the email message: the sender's address, the bad recipient's email address, and the time the email message was sent.

In order to determine whether the sender is a spammer, step 107 retrieves the sender status from the second database 201 which indicates whether the sender is or is not a considered a spammer. Step 209 uses the sender status to determine “Is sender a spammer?” If the sender is new and a sender status has not been determined it is assumed that the sender is not a spammer. This a temporary situation since when the sender sends an email message, in step 205 the system will store bad recipient information and quickly be able to determine a sender status. If the sender is a spammer then step 113 holds the email message from delivery to the recipients. If the sender is not a spammer then step 115 releases the email message for delivery to the recipients.

FIG. 3 shows an exemplary schematic of a computer-based system 300 to periodically calculate sender activity to bad recipients and to determine sender status for senders of email messages in accordance with the method shown in FIG. 2. At predetermined intervals, selected by the administrator and stored in the second database 201, sender activity to bad recipients is calculated for the predetermined time interval. Step 301 retrieves stored information which may consist of bad recipient information for the predetermined time interval (sender address, bad recipient address, time the email message was sent by the sender), general sender information which may include sender address, sender status, and previously calculated totals of sender activity to bad recipients (e.g., bad recipients counts and bad messages counts), and thresholds for determining sender status from calculated totals of sender activity to bad recipients, etc.

Step 303 calculates using information obtained when stored information is retrieved in step 301. For senders who sent email messages to bad recipients during the predetermined time interval, a bad recipients count and a bad messages count are calculated. If a sender sent numerous email messages to a particular bad recipient during the predetermined time interval, the particular recipient would only be added once to the bad recipients count while all of the email messages sent to the particular recipient would be added to the bad messages count.

The bad recipients count and the bad messages count indicate whether a sender has been a good sender or a spammer over the predetermined time interval. Since zombies and botnets have become the preferred tools of spammers, this is important information. A good user, when suddenly taken over as a zombie, will be quickly turned into a spammer. Once the zombie software is removed from the user's computer, the user will be quickly turned back into a good user. The predetermined time interval may be adjusted by the administrator to a value that best reflects conditions on a particular email system.

Step 305 may use the bad recipients count and the bad messages count used to answer the question “Has sender status changed?”. The counts are compared to threshold values obtained from the second database 201 when stored information is retrieved 301 and the sender status for the predetermined time interval is then determined. The threshold values may be set by the administrator to better reflect conditions in a particular email system. Counts greater than a high threshold value may indicate the sender is a good sender. Counts less than a low threshold value may indicate the sender is a spammer. Counts between the high and low threshold values may be indeterminate and not clearly indicate whether the sender is a spammer or a good sender. Other embodiments may, at the discretion of the administrator, also compare the current set of counts to counts from previous periodic time intervals. If the sender status has changed then procedures for changed sender status 307 are executed. If the sender status has not changed then procedures for unchanged sender status 309 are executed.

Procedures for changed sender status 307 may include notifying the administrator of the change, updating the sender status in the second database 201, updating the bad recipients and bad messages counts in the second database 201, updating the unique good and bad senders along with the unique good and bad sender counts for recipients and the average recipient, and changing recipients on the bad recipients list based on the changing unique good and bad sender counts for recipients. Changes made to the bad recipients may be done periodically at an interval set and adjusted by an administrator to best suit a particular email system. Procedures for unchanged sender status 309 may include updating the bad recipients and bad messages counts in the second database 201.

### EXAMPLE

The first embodiment is illustrated by an example for determining a sender reputation of a new sender sending an email message for the first time. In this example there are seven existing senders (senders A, B, C, D, E, F, and G). As shown in Table 1, existing senders A, B, D, and F are good senders and existing senders C, E, and G are bad senders.

TABLE 1

| | | Count of | Count of |
|---|---|---|---|
| | | Unique Good | Unique Bad |
| Good Senders in | Bad Senders | Senders in | Senders in |
| the System | in the System | the System | the System |
| A B D F | C E G | 4 | 3 |

Table 2 shows existing sender activity to the recipients where sender A has sent email messages to recipients T, U, V, W, and the average recipient

sender B has sent email messages to recipients V, W, X, and the average recipient

sender C has sent email messages to recipients V, Y, Z, and the average recipient

sender D has sent email messages to recipients U, V, Z, and the average recipient

sender E has sent email messages to recipients T, U, X, and the average recipient

sender F has sent email messages to recipients T, V, X, Z, and the average recipient

sender G has sent email messages to recipients V, W, Z and the average recipient.

TABLE 2

| | | | | Count of |
|---|---|---|---|---|
| | | | Count of | Unique Bad |
| | Unique Good | Unique Bad | Unique Good | Senders |
| | Senders | Senders | Senders | Sending to |
| | Sending | Sending to | Sending to | the |
| Recipient | to the Recipient | the Recipient | the Recipient | Recipient |
| T | A F | E | 2 | 1 |
| U | A D | E | 2 | 1 |
| V | A B F | C G | 3 | 2 |
| W | A B | G | 2 | 1 |
| X | B F | E | 2 | 1 |
| Y | D | C | 1 | 1 |
| Z | D F | C G | 2 | 2 |
| Average | A B D F | C E G | 4 | 3 |
| Recipient | | | | |

For this example, the new sender has sent the email message to recipients T, U, and V. Recall that a sender reputation is calculated by multiplying the existing sender reputation by the recipient reputations of the unique recipients of the email message. Also, recall that if the sender is new, a sender reputation may be initialized with a value of one (1).

Also recall that a recipient reputation is calculated using the following formula

(a count of unique ham senders sending email messages to the recipient/a count of unique spam senders sending email messages to the recipient)/(a count of unique ham senders sending email messages the average recipient/a count of unique spam senders sending email messages the average recipient)

Using Table 2 we can determine the recipient reputations for the three recipients (recipients T, U, and V) of the first email message from the new sender. The recipient reputation for recipient T is ((2/1)/(4/3)), the recipient reputation for recipient U is ((2/1)/(4/3)), and the recipient reputation for recipient V is ((3/2)/(4/3)).

Since the sender is a new sender and the unique recipients of the new senders first email message are recipients T, U, and V, the formula for calculating the sender reputation of the new sender is (the initialized new sender reputation)*(the recipient reputation of recipient T)*(the recipient reputation of recipient U)*(the recipient reputation of recipient V). Using the values illustrated in the preceding paragraphs we have the following formula: (1)*((2/1)/(4/3))*((2/1)/(4/3))*((3/2)/(4/3)) which equals (1)*(1.5)* (1.5)*(1.125) which equals 2.53125. Assuming the administrator has set a threshold of 1.25 where senders with reputations greater than the threshold are considered good senders, the new sender with a sender reputation of 2.53125 is classified as a good sender.

The next time this, no longer new, sender sends an email message, the sender reputation of 2.53125 will be multiplied with the recipient reputations of the unique recipients of the email message to determine the updated sender reputation.

In the foregoing specification, the present invention has been described with reference to specific embodiments thereof It will, however, be evident to a skilled artisan that various modifications and changes can be made thereto without departing from the broader spirit and scope of the present invention as set forth in the appended claims. For example, although a method of the present invention is described primarily in reference to filtering email messages being sent from an email system, skilled artisans will appreciate that the present invention may also be practiced with filtering email messages being received by the email system. Furthermore, to the extent that the term “includes” is used in either the detailed description or the claims, such term is intended to be inclusive in a manner similar to the term “comprising” as “comprising” is interpreted when employed as a transitional word in a claim. The specification and drawings are, accordingly, to be regarded in an illustrative rather than a restrictive sense.

What is claimed is:

1. A method for determining whether a sender of an email message is a spammer, the method comprising:
accumulating information pertaining to recipients of email messages;
determining recipient reputations based on the accumulated information for the recipients of the email messages;
determining a sender indicator for the sender of the email message based on the recipient reputations of the recipients of the email message;
determining whether the sender is a spammer based on the sender indicator; and
filtering the email message based on the determination of whether the sender is a spammer.

2. The method of claim 1 wherein the accumulated information includes sender information pertaining to good senders and spammers.

3. The method of claim 1 wherein the accumulated information includes threshold values.

4. The method of claim 1 wherein determining recipient reputations is based on the accumulated information.

5. The method of claim 1 wherein determining the sender indicator is based on the accumulated information.

6. The method of claim 1 wherein determining a recipient reputation comprises calculating for a recipient, (a count of unique ham senders sending email messages to the recipient/a count of unique spam senders sending email messages to the recipient)/(a count of unique ham senders sending email messages to an average recipient/a count of unique spam senders sending email messages to an average recipient.

7. The method of claim 1 wherein the sender indicator is determined by multiplying the recipient reputations of unique recipients of the email message with a stored sender indicator.

8. The method of claim 1 wherein the accumulated information is updated based on an updated determination of the sender indicator.

9. The method of claim 1 further comprising compiling a set of email addresses of bad recipients.

10. The method of claim 9 wherein the set of email addresses of bad recipients is compiled using the accumulated information.

11. The method of claim 9 wherein the set of email addresses of bad recipients is compiled using the recipient reputations.

12. The method of claim 9 wherein the set of email addresses of bad recipients is compiled from a mailing list from a known spammer.

13. The method of claim 9 wherein the set of email addresses of bad recipients is compiled using at least one recipient email address collected from at least one email message sent by at least one sender regarded as a spammer.

14. The method of claim 9 wherein the accumulated information includes email addresses of the recipients in the set of email addresses of bad recipients.

15. The method of claim 9 wherein the accumulated information includes threshold values.

16. The method of claim 9 wherein the accumulated information includes, for the email messages sent to the recipients in the set of email addresses of bad recipients, a recipient email address, a sender email address, and a time the email message was sent.

17. The method of claim 9 wherein the sender indicator is determined based on the email messages sent to the recipients in the set of email addresses of bad recipients.

18. The method of claim 9 wherein the sender indicator is determined based on a first count of unique recipients in the set of email addresses of bad recipients to whom the sender has sent the email messages over a given interval of time.

19. The method of claim 9 wherein the sender indicator is determined based on a second count of the email messages sent from the sender, over a given interval of time, to the recipients in the set of email addresses of bad recipients.

20. A method for determining whether a sender of an email message is a spammer, the method comprising:
compiling a list of bad recipients, the list of the bad recipients comprising email addresses of recipients considered likely to receive spam email messages;
storing sender activity data pertaining to email messages sent to the bad recipients;
accumulating a first set of counts of the email messages sent by the sender to the bad recipients over a given time interval using the sender activity data;
accumulating a second set of counts of unique bad recipients to whom the sender has sent the email messages over the given time interval using the sender activity data;
making a first determination whether the sender is a spammer by comparing the first set of counts to a first threshold;
making a second determination whether the sender is a spammer by comparing the second set of counts to a second threshold;
filtering the email message based on at least one of the first determination and the second determination of whether the sender is a spammer; and
updating the list of the bad recipients based on at least one of the first determination and the second determination.

21. A method for determining whether a sender of an email message is a spammer, the method comprising:
compiling a list of bad recipients, the list of the bad recipients comprising email addresses of recipients considered likely to receive spam email messages;
storing sender activity data pertaining to email messages sent to the bad recipients;
accumulating counts of the email messages sent by the sender to the bad recipients over a given time interval using the sender activity data;
determining whether the sender is a spammer by comparing the counts to a threshold;
filtering the email message based on the determination of whether the sender is a spammer; and
updating the list of the bad recipients based on the determination of whether the sender is a spammer.

22. A method for determining whether a sender of an email message is a spammer, the method comprising:
compiling a list of bad recipients, the list of the bad recipients comprising email addresses of recipients considered likely to receive spam email messages;
storing sender activity data pertaining to email messages sent to the bad recipients;
accumulating counts of unique bad recipients to whom the sender has sent the email messages over a given time interval using the sender activity data;
determining whether the sender is a spammer by comparing the counts to a threshold;
filtering the email message based on the determination of whether the sender is a spammer; and
updating the list of the bad recipients based on the determination of whether the sender is a spammer.
